(19) United States
(12) Patent Application Publication
(10) Pub. No.: US 2010/0255266 A1
(43) Pub. Date: Oct. 7, 2010

(54) Stimuli Responsive Mesoporous Materials for Control of Molecular Transport

(76) Inventors: Quiang Fu, Albuquerque, NM (US); Venkata R. Goparaju, Edmond, OK (US); Linnea K. Ista, Albuquerque, NM (US); Yang Wu, Albuquerque, NM (US); Brett P. Andrzejewski, Albuquerque, NM (US); Yunfeng Lu, New Orleans, LA (US); Larry A. Sklar, Albuquerque, NM (US); Timothy L. Ward, Albuquerque, NM (US); Gabriel Lopez, Albuquerque, NM (US)

Correspondence Address: GONZALES PATENT SERVICES, 4605 CONGRESS AVE. NW, ALBUQUERQUE, NM, 87114, US

(21) Appl. No.: 11/682,396

(22) Filed: Mar. 6, 2007

Related U.S. Application Data
(63) Continuation of application No. 10/826,667, filed on Apr. 16, 2004, now abandoned.
(60) Provisional application No. 60/463,030, filed on Apr. 16, 2003.

(51) Int. Cl. B32B 3/28; B32B 3/26

(52) U.S. Cl. 428/182; 428/338

(57) ABSTRACT

The present subject matter relates generally to design, synthesis, and characterization of materials with well-defined porous networks of molecular dimensions in which the size and surface energy of the pores can be externally and reversibly controlled to dynamically modulate the adsorption and transport of molecular species.

### CROSS-REFERENCE TO RELATED APPLICATION

This application is a continuation of U.S. Provisional patent application Ser. No. 10/826,667 filed Apr. 16, 2004, which claims the benefit of U.S. Provisional patent application Ser. No. 60/463,030, filed Apr. 16, 2003, both of which are incorporated herein by reference.

### GOVERNMENT FUNDING

The invention described herein was made with government support under the following grant numbers, N-00014-00-1-0183 (ONR), F49620-01-1-0168 (AFOSR), EE C-0210835 (NSF), and GM60799/EB00264 (NIH). The United States Government may have certain rights in the invention.

### BACKGROUND

Stimuli responsive polymers (SRPs) comprise a class of synthetic, naturally occurring and semi-synthetic polymers, which exhibit discrete rapid and reversible changes in conformation as a response to environmental stimuli. These stimuli may include temperature, pH, ionic strength, electrical potential and light. Some of the most studied of these so-called smart polymers are hydrogels which change their water content and excluded volume, in response to temperature. Various types of stimuli responsive polymers in ensembles to control the permeability of solutes and fluids through membranes or through bulk materials have been described. In recent years, these types of polymers have been developed for a variety of different applications including drug delivery, control of protein activity and most interestingly, systems that mimic natural cellular components, such as cellular membranes and secretory granules. Smart polymers that have found use in biotechnology and medicine have been described by I Yu Galaev in Russian Chemical Reviews 64: 471-489 (1995); A. S. Hoffman in Clinical Chemistry 46:1478-1486 (2000) and H. G. Schild, Prog. Polym. Sci. 17, 163 (1992).

Previous methods for the use of stimuli responsive polymers for the dynamic control of molecular permeability have limited ability for independent and precise control for a variety of applications. Hence, there currently is a need to enhance the application of stimuli responsive polymers.

### SUMMARY OF THE INVENTION

The present subject matter relates to the design of mesoporous materials in which the transport properties of highly ordered pores of molecular dimensions can be externally and reversibly modulated. Applicants have discovered that the presence of poly(N-isopropyl acrylamide), a stimuli responsive polymer, in a porous network can be used to modulate the transport of aqueous solutes. One embodiment is the modification of mesoporous materials by atom transfer radical polymerization components to allow dynamic control of size selective molecular transport. Another embodiment is direct surfactant templating of hybrid copolymers to achieve dynamic control of size selective molecular transport. In yet another embodiment, a method for forming a mesoporous material including modifying pores of a mesoporous material with a stimuli responsive polymer and maintaining an ordered porous structure and an increase in inter-pore spacing.

### BRIEF DESCRIPTION OF THE FIGURES

FIGS. 1A-C illustrate the characterization of smart porous materials formed by surface tethered living radical polymerization within mesoporous silica.

FIGS. 2A-E illustrate the uptake and release of fluorescent dyes from ATRP-modified microparticles.

FIGS. 3A-C illustrate the characterization of smart porous materials formed by copolymerization of NIPAAM and silica.

FIG. 4A illustrates comparison of the flow cytometry data.

FIG. 4B illustrates comparison of the confocal microscopy data.

FIG. 5 illustrates wettability data for mesoporous material of the present invention.

FIGS. 6A-E illustrate topographical AFM images.

FIGS. 7A-B illustrate pixel intensity histograms.

FIG. 8 is a graph showing the release of fluorescein from the polymer grafted particles at two different temperatures as measured by spectrofluorimetry.

FIG. 9 is a graph showing a comparison of flow cytometry results (fluorescein release at 50οC, FIG. 2B) with theory (equation 4).

FIG. 10 is a comparison of confocal microscopy results (rhodamine 6G at 50° C., FIG. 2D) with theory (equation 3).

### DETAILED DESCRIPTION

In the following detailed description, reference made to the accompanying drawings which form a part hereof, and which is shown by way of illustration specific embodiments in which the invention may be practiced. These embodiments are described in sufficient detail to enable those skilled in the art to practice the invention, and it is to be understood that other embodiments may be utilized and that structural changes may be made without departing from the present invention.

The terms “mesoporous materials” or “mesoporous particles” as used herein includes porous network, microparticles, nanoparticles, nanostructured surfaces, nanotextured surfaces, supported membranes, and patterned microstructures. It will be appreciated by those skilled in the art that other related materials may be used to the control molecular transport and surface reactivity.

The term “stimuli responsive polymer” as used herein includes polymers that are sensitive to their environment or externally applied impetus.

The control of transport of aqueous molecular solutes through porous materials as described herein is critical in a number of technological areas including chromatography, membrane separations, drug delivery and environmental remediation. Control of nanotopography is also important in these areas, because of its capacity for synergistic amplification of surface phenomena and because of its ability to influence steric interactions in molecular transport and surface reactivity. The methods of the present subject matter are based on the formation of ordered mesoporous architectures via surfactant templating during sol-gel polymerization of silica and control of transport and surface properties of the mesoporous materials through the use of stimuli responsive polymers (SRPs, a.k.a. smart polymers). In an embodiment, poly(N-isopropyl acrylamide) is employed as a SRP (PNIPAAm). PNIPAAm is a temperature sensitive SRP which undergoes an aqueous lower critical solubility transition at −32° C. when in bulk solution. When this SRP is present on a surface the solubility transition can be manifested as a change in polymer excluded volume and a change in surface energy. On a pore surface these two properties can be tuned through choice of SRP and surface immobilization conditions to greatly effect adsorption and transport characteristics.

The present subject matter includes methods wherein a versatile nanostructured surface based on nanoporous aluminum oxide formed via anodization is modified by poly(N-isopropyl acrylamide) with thickness comparable to the surface corrugation. This allows direct correlation of changes in surface energy and nanotopography on macroscopic surface phenomena such as wettability.

The results of embodiments of the present invention demonstrate that the presence of a stimuli responsive polymer in the porous network may be used to modulate the transport of aqueous solutes. In one embodiment, a stimuli responsive polymer may be used to change the thickness and surface energy of a porous network as a function of temperature. At low temperatures (for example, room temperature), the stimuli responsive polymer is extended and inhibits the transport of solutes. At higher temperatures (at least about 35° C.), the stimuli responsive polymer is collapsed within the pore network and allows solute diffusion.

In one embodiment, placement of the stimuli responsive polymer within the porous network resulted in an increase in the inter-pore spacing by about at least about 30%. In another embodiment, placement of the stimuli responsive polymer within the porous network resulted in an increase in the inter-pore spacing by about at least 40%.

Although silica and poly(N-isopropyl acrylamide) have been chosen as a basis of demonstration, the design principles and synthetic methods are applicable to a wide variety of porous structures, polymers or molecules that are reversibly sensitive to external stimuli, such as temperature, pH, light, electricity, solutes, or enzymatic transformations.

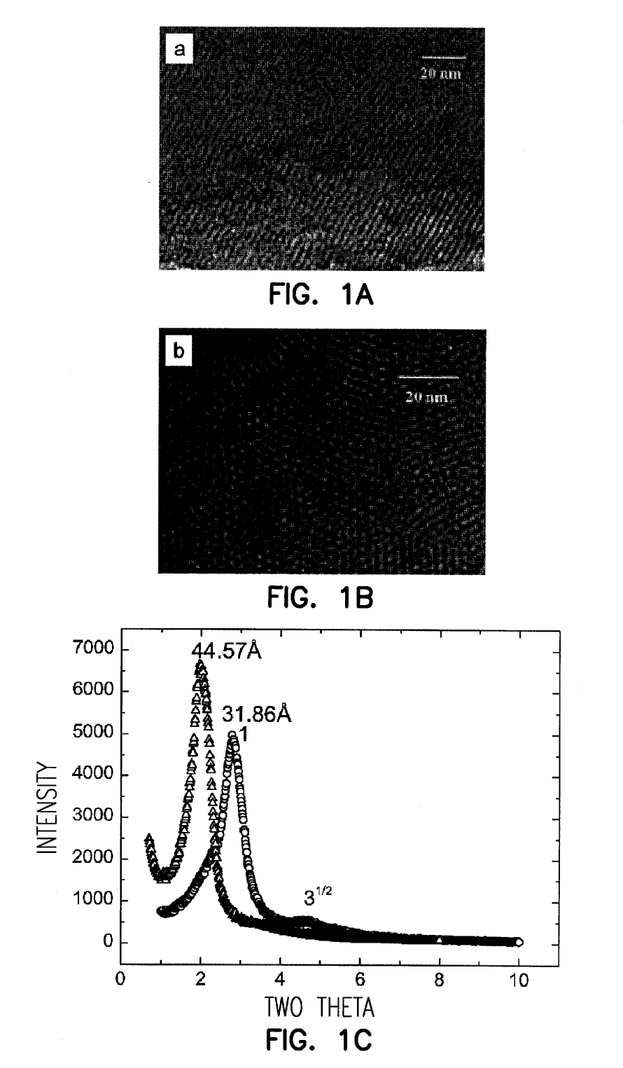

FIGS. 1A-C illustrate the characterization of smart porous materials formed by surface tethered living radical polymerization within mesoporous silica. FIGS. 1A and B show transmission electron microscopy (TEM) micrographs of microtomed samples of particles before and after modification of their porous network via ATRP of NIPAAm. ATRP is very useful for the modification of pore surfaces for two reasons. First, the lifetime of the radical on the surface is high (several hours) resulting in a relatively slow polymerization rate that allows uniform polyumerization in confined spaces. This property has been exploited in the formation of surface grafted polymer burshes with predictable molar masses, low polydispersity and controllable compositions. Secondly, polymerization is restricted to the surface such that no polymer forms in solution. This also prevents clogging of the pores with free polymer and enables uniform polymerization. We have recently shown that surface grafted brushes of PNIAPAAm prepared by ATRP on flat surfaces can exhibit substantial changes in thickness and surface energy as a function of temperature. At low temperatures, the brushes are hydrophilic, hydrated and extended; at higher temperatures, the brushes are relatively hydrophobic and thus dehydrate and collapse.

FIG. 1A shows the TEM micrograph of mesoporous silica formed by templating with CTAB after calcination and prior to surface modification. FIG. 1B shows the TEM micrograph of hybrid material after modification by surface initiated ATRP of PNIPAA. The hexagonal packing of the pores visible in FIG. 1B shows that the ordered porous structure is maintained through the polymerization process, with an increase in the inter-pore spacing. FIG. 1C shows the XRD patterns of porous materials before (ο) and after(Δ) ATRP.

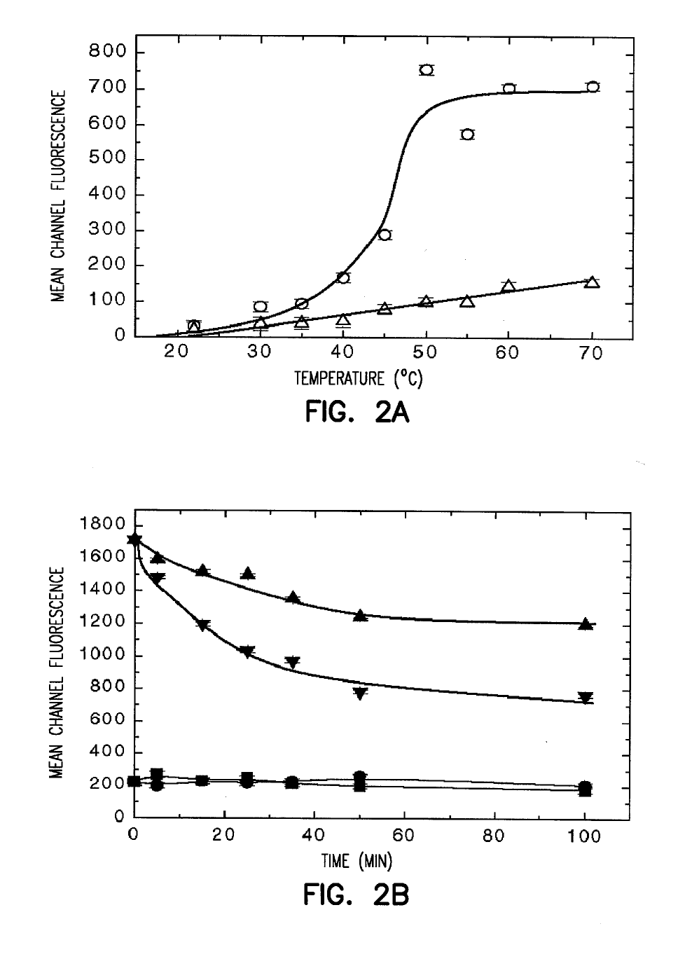

FIGS. 2A-C illustrate the uptake and release of fluorescent dyes from ATRP-modified microparticles. FIG. 2A shows the uptake of fluorescein into particles as a function of temperature as measured by flow cytometry. As shown in FIG. 2A, the untreated mesoporous silica (Δ) and PNIPAAm grafted mesoporous silica (ο) were immersed in dye (35 μM) for 2 h. FIG. 2B shows the release of fluorescein from PNIPAAm grafted mesoporous particles as a function of time as measured by flow cytometry. All samples were equilibrated in dye (35 μM) for 2 h. Fluorescence of beads incubated at 25° C. and released at 25° C. (•) and 50° C. (▪). Fluorescence of beads incubated at 50° C. and released at 25° C. (▴) and 50° C. (▾). FIG. 2C shows confocal micrographs demonstrating the release of rhodamine dye from the grafted particles at 50° C. FIG. 2D shows the time dependant line profiles of fluorescence intensities obtained at the vertical midline of the particle imaged in FIG. 2C. FIG. 2A shows data for uptake of the dye as a function of temperature after 2 hrs of immersion in 35 μM dye. In contrast to the bare silica particles, PNIPAAm modified particles showed enhanced uptake at high temperatures (>45° C.), at which the surface grafted polymer is in a collapsed, hydrophobic state. At lower temperatures, PNIPAAm is in an extended state that likely occludes the pores to prevent uptake of the dye. The range of temperatures over which the transition in the uptake takes place (˜35-50° C.) is quite broad, consistent with previous theoretical and experimental studies that have concluded that the solubility transition for polymer brushes in confined geometries is broad compared to that observed for free polymer in solution. Further evidence that PNIPAAm chains can be used to modulate molecular transport rates within the porous network is provided by data on the release of dye from the hybrid particles at low and high temperatures. FIG. 2B presents the fluorescence of dye loaded particles as a function of time after being washed and immersed in Tris buffer. A more rapid decrease in particle fluorescence is observed at 50° C. than at 25° C., indicating that the hydrated PNIPAAm chains restrict molecular diffusion at low temperatures. A concomitant increase in the solution fluorescence measured by parallel spectrofluorimetric measurements is also observed (Example 3). FIG. 2C presents confocal fluorescence images that show the time dependent release of rhodamine dye from a particle at 50° C. Fluorescence intensity profiles of the particle at various time intervals (FIG. 2D) provide a quantitative indication of the decrease in dye concentration within the particle due to its release. Images taken at 25° C. showed a much slower change in fluorescence.

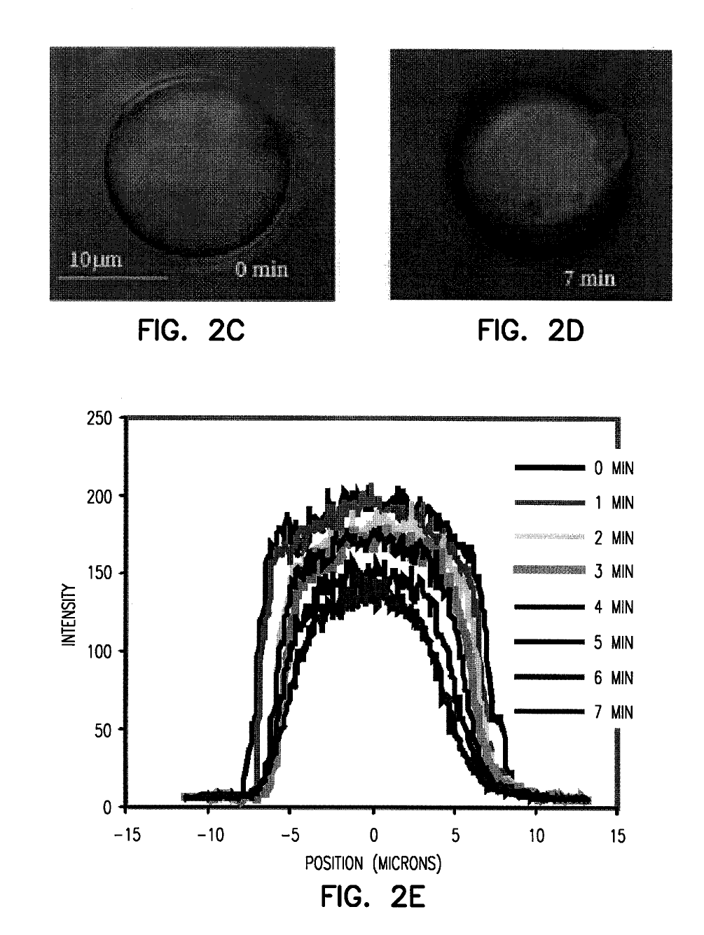

FIGS. 3A-C illustrate the characterization of smart porous materials formed by copolymerization of NIPAAM and silica. FIG. 3A shows the TEM micrograph of hybrid material before removal of surfactant templates. FIG. 3B shows the TEM micrograph of hybrid material after removal of surfactant templates. While the nanoscopic ordering of the material is clearly evident before surfactant removal, it is less clear after extraction of the surfactant. Analysis of XRD confirmed the presence of ordered structures both before and after solvent extraction, with a mixture of lamellar and hexagonal phases clearly indicated before surfactant extraction.

FIG. 3C shows the permeation of crystal violet solutions through hybrid membranes coated on centrifugal filters. Permeation was measured repeatedly after 3 min of centrifugation at a field of 400.×g while cycling between 25° C. and 50° C. “Permeation” indicates that the solution permeated through the membrane and that the concentration of the filtrate and the feed were measured to be the same. “No Permeation” indicates that not even a trace of water was observed to permeate through the filter.

FIG. 3C presents data on the permeability of hybrid membranes formed by spin coating of the precursor sol onto macroporous centrifugal filters. This data shows that molecular transport is inhibited at low temperature and enabled at high temperature and that temperature can be used to reversibly modulate the transport characteristics of the porous materials. Examination of the selectivity of molecular transport was conducted by measuring the permeation of poly(ethylene glycol) (PEG) in aqueous solutions (2 wt %) which varied in the molecular weight of PEG. Under controlled permeation conditions (50° C., 400×g), only PEGs with molecular weight less than 10,000 Da permeated through the membrane materials. At high temperatures the membranes act as molecular weight cut off filters (see Table 1). These results demonstrate that this synthetic approach can successfully be used to dynamically and reversibly modulate the permeation characteristics of porous networks that exhibit molecular size selectivity.

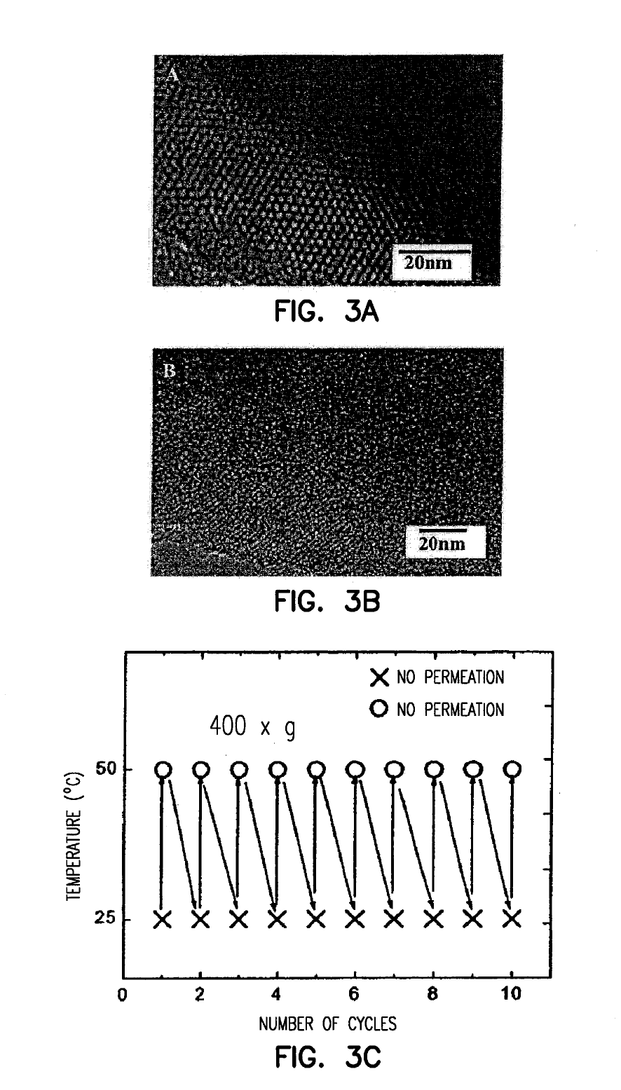

FIG. 4A illustrates a comparison of flow cytometry data (fluorescein release at 50° C.) with theory. Theory: Total amount of dye remaining in particles (M_{R}), normalized to total initial amount of dye (Mₒ). Experiment: mean channel fluorescence (I_{T}) as measured by the flow cytometer normalized to the initial value (l_{To}).

FIG. 4B illustrates Comparison of confocal microscopy date (rhodamine 6 G at 50° C., FIG. 2C) with theory. Theory: plot of normalized concentration at the center of the particle (C₁=initial uniform concentration in particle, Cₒ=constant surface concentration). Experiment: fluorescence intensity at center of particle normalized to the fluorescence intensity at t=0. Experimental values were shifted by 4 min to produce the match with the theory. This time is approximately that which elapsed between sample washing and the recording of the first fluorescence image (denoted as t=0 and 7 in FIGS. 2A,B, respectively).

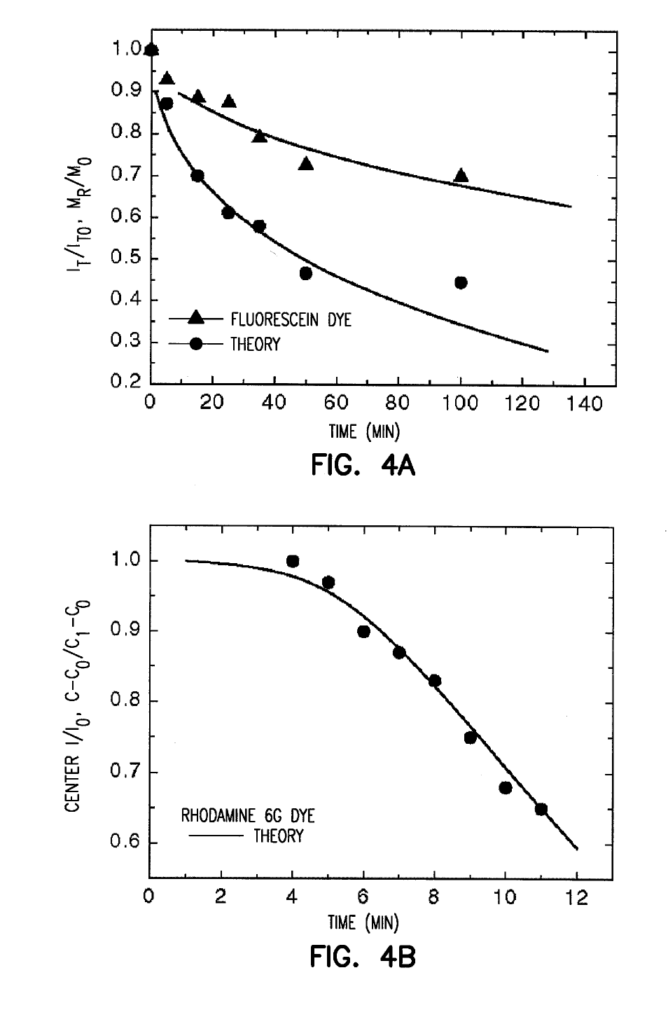

FIG. 5 illustrates wettability data for PNIPAAm grafted on the porous and nonporous surfaces at temperatures below and above the typical low critical solubility temperature observed for bulk solutions. In all cases change in temperature resulted in a change in water contact angle. Increasing the pore size of the substrate led to a gradual decrease in the contact angles measured at low temperature and a dramatic increase in contact angles measured at high temperature. The difference in contact angle measured at low and high temperature increased steadily, from ˜13° to 112°.

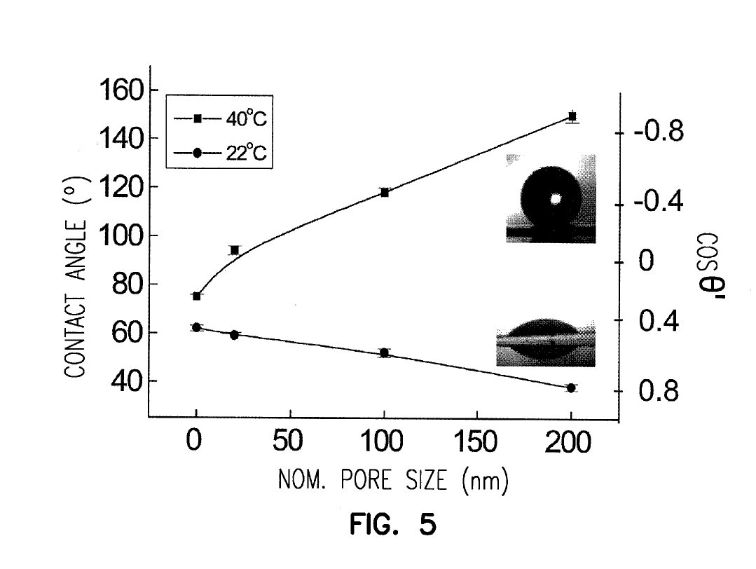

FIGS. 6A-C illustrate representative images for bare and PNIPAAm-modified anodic aluminum oxide membranes at temperatures below and above the low critical solubility temperature. The images reflect changes in the nanostructure due to differences in template pore size, surface grafting of PNIPAAm, and change in temperature for the PNIPAAm-modified surfaces. Roughness factors (actual surface area/projected surface area) obtained from the images of the PNIPAAm surfaces increased steadily as the pore size increased and increased significantly upon increase in temperature for the 20 nm (1.15 at 25° C. to 1.24 at 40° C.) and 100 nm (1.23 to 1.33). The 200 nm samples did not show a dramatic difference in roughness factor at low and high temperatures, consistent with the expectation that changes in topography due to swelling and contraction of the thin polymer layer are less significant for larger pore sizes. Repeated imaging of samples at high and low temperature demonstrated reversible change in the nanostructure of the PNIPAAm modified samples.

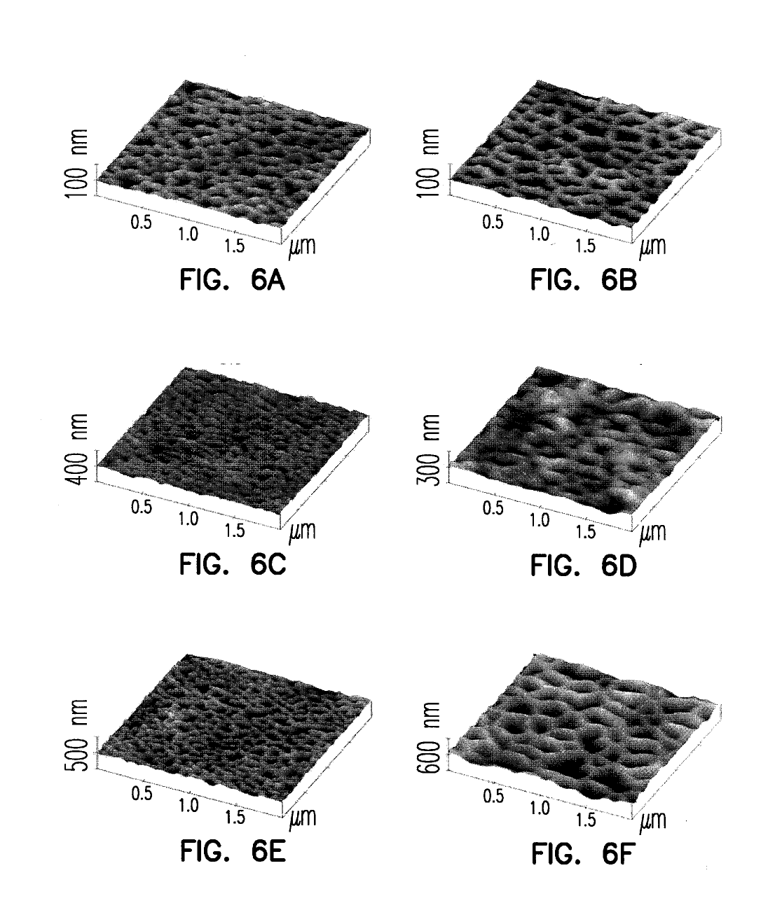

FIG. 7A shows intensity histograms for representative images of the different types of PNIPAAm-modified porous anodic aluminum oxide. A method based on principal components analysis (PCA), for quantitative correlation of changes in nanostructure, as visualized by atomic force microscopy (AFM), to changes in macroscopic water contact angles. Several multivariate statistical models based on PCA were developed to correlate features in the AFM images with measured macroscopic contact angles. The best correlations were obtained using PCA of the histograms of AFM pixel intensities. Another method that presented a meaningful relationship involved the use of PCA to correlate the Fourier transforms of the images. As shown in FIG. 7A, PCA of these histograms reveals that 91% of their variation is described by the 1^{st} principal component which is centered around the mean grey level intensity (˜125) and 8% is described by the 2^{nd} principal component that has two peaks near the extremes of the grey level intensity values (˜50 and ˜165).

FIG. 7B shows the correlation of the first and second principal components of the variation in the intensity histograms with macroscopic wettability. FIG. 7B demonstrates that these principal components are linearly correlated with the cosine of the contact angles, and thus that AFM can be used in the quantitative prediction of a dynamic macroscopic property, e.g., the wettability.

The combined results of FIGS. 5-7 show that it is possible to dynamically change crucial surface properties—the size of surface pores, the surface roughness, and the effective interfacial energy—on the nanometer scale using surface-grafted stimuli responsive polymers. The changes are controllable and reversible, and are reflected in large changes in contact angle, and in easily visible changes in AFM images. Finally the changes in macroscopic surface hydrophobicity can be quantitatively related to changes in microscopic surface structure using principle component analysis.

All of the methods described above for monitoring the release of fluorescent dyes from the particles can be used to estimate the effective diffusion coefficient (D_{eff}) of the dyes in the porous structure. A simple method is to adopt a model that treats the particle as a homogeneous continuum with spherical symmetry. The effects of porosity and tortuous nature of the pore structure are included in the observed D_{eff}. The time dependant diffusion equation then reduces to a simple equation with one spatial coordinate, which has been solved analytically for various boundary and initial conditions:

$$\frac{\partial C}{\partial t} = {D}_{eff} \cdot \frac{1}{{r}^{2}} \frac{\partial }{\partial r} ( {r}^{2} \frac{\partial C}{\partial r} )$$

Solution with a uniform initial dye concentration throughout the bead and constant concentration at the bead surface (reasonable assumptions for the cytometry and confocal microscopy experiments) yields effective diffusion coefficients for fluorescein and rhodamine dyes at 50° C. of 2×10⁻¹¹ and 3×10⁻¹⁰ cm²/s, respectively (see Examples 4 and 5).

The invention will now be illustrated by the following non-limiting Examples.

### EXAMPLE 1

Synthesis Of Mesoporous Silica

Synthesis of mesoporous silica was carried out using a two-step acid-catalyzed sol-gel process (as described by Lu et al., Nature, 398, 223 (1999)). Cetyltrimethyl ammonium bromide, a cationic surfactant was used as a structure-directing agent for the preparation of particles. In a typical preparation, tertraethylorthosilicate (TEOS) (Aldrich), ethanol, deionized water (conductivity less than 18.2 MΩ cm), and dilute HCl (mole ratios 1:3.8:1:0.0005) were refluxed at 60° C. for 90 min to provide the stock sol. 20 mL of stock sol was diluted with ethanol, followed by addition of water , dilute HCl, and aqueous surfactant solution (2.5 g of surfactant dissolved in 20 mL of water) to provide final overall TEOS/ethanol/H₂O/HCl surfactant molar ratios of 1:27:55:0.0053:0.19. The monodisperse droplets were generated by means of a vibrating orifice aerosol generator (VOAG) (TSI Model 3450). In the VOAG, the aerosol solution was forced through a small orifice 20 μm by a syringe pump, with fluid velocities of approximately 8×10⁻⁴ cm s⁻¹ (˜4.7×10⁻³ cm³ s⁻¹). The particles were collected on a filter maintained at approximately 80° C. by a heating tape and were subsequently calcined at 400° C. for 4 h to remove the surfactant.

### EXAMPLE 2

Synthesis Of Grafted Particles

Monodisperse mesoporous silica microparticles (as reported by S.H. Chung, S. Kuyucak, Eur. Biophys. J. Biophys. Lett. 31 , 283 (2002)), were modified by surface grafting according to the procedure described by Huang and Wirth in Anal. Chem., 69, 4577 (1997) and adapted to N-isopropylacrylamide (NIPAAm). Hydroxyl groups were created on the silica surface by treatment with concentrated HNO₃ for 4 h and subsequent washing with ultra pure (>18 MΩ resistance) water and then drying at 110° C. for 2 h under N₂ stream. These particles were then added to a reactor containing 0.5 mL of the initiator, 1-(trichlorosilyl)-2[m/p-(chloromethyl) phenyl]ethane and 50 mL of anhydrous toluene. The reaction was carried out at room temperature for 12 h. The silica particles were then washed with toluene, methanol, and acetone and dried at 110° C. for 2 h. Atom transfer radical polymerization (ATRP) was performed on the initiator-derivatized particles. 0.2 g of silica particles were combined with 0.107 g CuCl, 0.5 g of bipyridine, and 3 g of NIPAAm (Aldrich) in 30 mL of dimethyl formamide. The reaction flask was deoxygenated with N₂ for 40 minutes and then sealed under N₂. The reaction took place at 130° C. for 40 h with stiffing. The grafted particles were then washed with methanol and water and dried at 70° C. under a stream of N₂.

Characterization

The particles were characterized by scanning electron microscope (Hitachi S-800) and X-ray diffraction (Siemens D5000, CuK_{α}radiation 1=1.5418 Å). Surface area and pore size distribution studies were carried out using nitrogen adsorption and desorption at 77K using a Micromeritics ASAP 2000 porosimeter. Sample preparation for cross-sectional transmission electron microscopy (JEOL 2010 200 KV) required the particles to be embedded in an epoxy and then cross-sectioned using a Sorvall MT-5000 Ultra Microtome machine.

Spectrofluorimetry

Spectrofluorometric measurements were carried out using a Fluorolog-3 (ISA INC./Jobin Yvon Inc ,NJ). 2.0 mg of polymer-modified particles were added to 1.0 mL of 0.035 mM fluorescein (sodium salt) in Tris (0.05 M, pH 7.4) buffer and were incubated at either 25 or 50° C. for 2 h. The samples were then cooled down to room temperature (˜25° C.), and equilibrated at this temperature for at least 40 min. The particles were washed 3× in fresh Tris buffer. The dye concentration in the supernatant was then measured and returned to the beads. The samples were then incubated either at 50° C. or 25° C., the temperature being the same as the initial incubation conditions. Dye release was measured at various intervals during incubation.

Flow Cytometry

Polymer-modified particles (1.0 mg) were added to 1.0 mL of 0.035 mM fluorescein in Tris buffer (0.05 M, pH 7.4) and were incubated at either 25 or 50° C. for 2 h. The samples were then cooled down to room temperature (−25° C.), and equilibrated at this temperature for at least 40 min. The particles were then washed 3× in fresh Tris buffer. Flow cytometry recorded the dye remaining in the particles at both 50° C. and 25° C. The uptake of dye was also measured, using flow cytometry, at various temperatures to examine the temperature response of the grafted polymer.

Bead suspensions were analyzed by flow cytometry using a Becton-Dickinson FACScan flow cytometer (Sunnyvale, Calif.) interfaced to a Power PC Macintosh using the Cell Quest software package. The FACScan is equipped with a 15 mW air-cooled argon ion laser. The laser output wavelength is fixed at 488 nm. Experimental details of these analyses have been described elsewhere.

Confocal Laser Scanning Microscopy

5.0 mg of polymer grafted particles were incubated in 0.4 mL of an aqueous solution containing 0.5 mM of rhodamine 6G (Molecular Probes) at either 25 or 50° C. overnight. The samples were then cooled to room temperature (˜25° C.), and equilibrated at this temperature for at least 40 mM The particles were washed 2× with water at room temperature. The dye remaining in the particles was observed at 50° C. or 25° C. using a confocal laser scanning microscope at regular intervals.

Confocal laser scanning microscopy was performed on a Zeiss Axiovert microscope using an LSM 510 (Carl Zeiss) scan head. Simultaneous DIC imaging was performed using the scan head and LSM software and a Plan Neo Fluor 40×/1.3 NA oil immersion lens. A HeNe laser (543 nm) was used to excite fluorescence. Samples were heated by placing a suspension of particles on a slide supported on a heating stage constructed from an aluminum block and a self-adhesive heating element. Temperature of the sample was probed using a thermocouple.

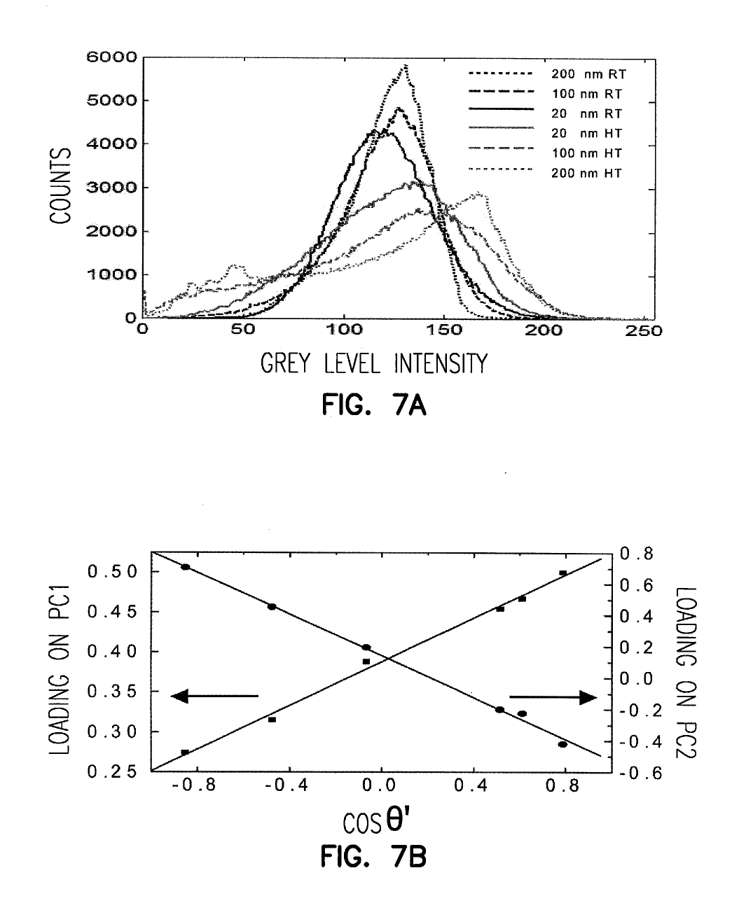

FIG. 8 is a graph showing the release of fluorescein from the polymer grafted particles at two different temperatures as measured by spectrofluorimetry.

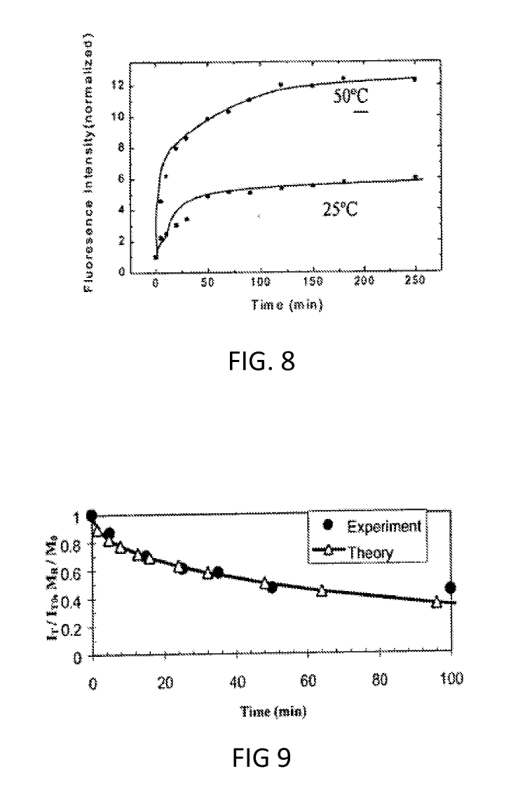

FIG. 9 is a graph showing a comparison of flow cytometry results (fluorescein release at 50οC, FIG. 2B) with theory (equation 4). Theory: Total dye remaining in particle, normalized to total initial dye. Experiment: mean channel fluorescence as measured by flow cytometer normalized to initial value.

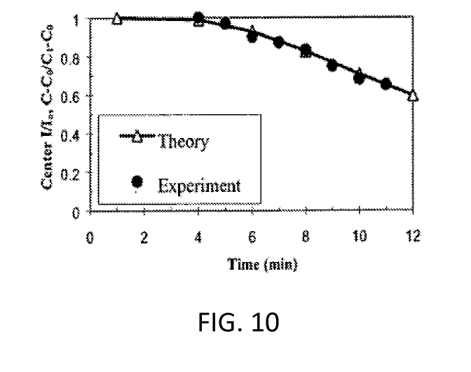

FIG. 10 is a comparison of confocal microscopy results (rhodamine 6G at 50° C., FIG. 2D) with theory (equation 3). Theory: plot of normalized concentration at the center of the particle (C₁=initial uniform concentration in particle, Cₒ=constant surface concentration). Experiment: fluorescence intensity at center of particle normalized of the fluorescence intensity at t=0. Experimental values were shifted by 4.0 minutes to produce the match with the theory. This time is approximately that which elapsed between sample washing and the recording of the first fluorescence micrograph (denoted as time=0 in FIG. 2 C, D).

Permeation Experiments

Permeation experiments were carried out using an Eppendorff 5415C centrifuge at temperatures of 25 and 50° C. with a controlled temperature of ±1° C. For PEG (M_{w}/Mₙ˜1.1) experiments (2 wt % aqueous solutions), the concentration of the filtrate was determined from refractive index measurements using a Kernco refractometer by comparing to a calibration curve obtained by measuring the refractive index of known concentrations of PEG. The minimum concentration of PEG, which can be measured using our refractometer, was determined to be 0.3 wt %. Table 1 shows the permeation data of PEGs through copolymer membranes.

TABLE 1
Permeation of PEG solutions (300 μL) at 50°
C. through copolymer membrane (surfactant removed)
coated on macroporous filters (Millipore YM-30).

| | Refractive index | Refractive index | |
|---|---|---|---|
| Molecular weight | of feed solution | of filtrate | Rejection |
| of PEG (Mn) | (±0.0002) | (±0.0002) | [%] |
| 5850 | 1.3350 | 1.3351 | 0 |
| 7200 | 1.3353 | 1.3353 | 0 |
| 9000 | 1.3356 | 1.3354 | 0 |
| 10000 | 1.3355 | 1.3331 | 100 |
| 14300 | 1.3354 | 1.3330 | 100 |
| 29000 | 1.3359 | 1.3330 | 100 |

All publications, patents, and patent documents are incorporated by reference herein, as though individually incorporated by reference. The invention has been described with reference to various specific and preferred embodiments and techniques. However, it should be understood that many variations and modifications may be made while remaining within the spirit and scope of the invention.

We claim:

1. A mesoporous material comprising:
a mesoporous network, wherein the network is formed from a plurality of ATRP-modified mesoporous microparticles comprising a plurality of pores; and
wherein, said ATRP modification results in a plurality of stimuli responsive polymers grafted from the modified pores, wherein the plurality of stimuli responsive polymers have substantially uniform chain lengths and are spaced at regular intervals throughout the porous network, so as to control the transport of a molecular species through the porous network.

2. The material of claim 1, wherein adsorption of the molecular species by the mesoporous network is controlled by exposure of the stimuli responsive polymer to at least one stimuli.

3. The material of claim 1, wherein the mesoporous network changes thickness and surface energy as a function of temperature.

4. The material of claim 1, wherein the mesoporous network comprises silica.

5. The material of claim 1, wherein the stimuli responsive polymer comprises a poly N-isopropylacrylamide polymer.

6. The material of claim 5, wherein the poly N-isopropylacrylamide polymer is extended and inhibits the transport of molecular species though the mesoporous network at a low temperature.

7. The material of claim 5, wherein the poly N-isopropylacrylamide polymer is collapsed within the porous network and allows transport of molecular species through the mesoporous network at a high temperature.

8. The mesoporous material of claim 1 wherein the mesoporous network has a well-controlled self-supporting architecture.

9. The mesoporous material of claim 8 wherein the mesoporous network is planar.

10. The mesoporous material of claim 8 wherein the mesoporous network is a bead.

11. The mesoporous material of claim 1 wherein the mesoporous network forms a switchable corregated surface.

12. The mesoporous material of claim 11 wherein the surface energy of the switchable corregated surface is configured to change in response to exposure of the mesoporous network to a stimuli.

13. The mesoporous material of claim 12 wherein the stimuli is selected from the group consisting of: a change in temperature, a change in pH, a change in ionic strength, a change in electrical potential, a change in light, a change in viscosity, a change in redox potential, and a change in mechanical tension.

14. The mesoporous material of claim 1 wherein transport of the molecular species through the material is prohibited upon exposure of the stimuli-responsive material to a stimuli.

15. The mesoporous material of claim 14 wherein the stimuli is selected from the group consisting of: a change in temperature, a change in pH, a change in ionic strength, a change in electrical potential, a change in light, a change in viscosity, a change in redox potential, and a change in mechanical tension.

16. The mesoporous material of claim 3 wherein the stimuli is selected from the group consisting of: a change in temperature, a change in pH, a change in ionic strength, a change in electrical potential, a change in light, a change in viscosity, a change in redox potential, and a change in mechanical tension.

17. A mesoporous material comprising:
a mesoporous network comprising a plurality of mesoporous microparticles;
wherein the mesoporous microparticles comprise a plurality of stimuli responsive polymers grafted from the pores, spaced at regular intervals, and having substantially uniform chain lengths.

18. The material of claim 17, wherein the mesoporous network comprises silica.

19. The material of claim 17, wherein the stimuli responsive polymer comprises a poly N-isopropylacrylamide polymer.

20. The mesoporous material of claim 1 wherein the mesoporous network forms a corregated surface.
